(19) United States
(12) Patent Application Publication
(10) Pub. No.: US 2024/0343986 A1
(43) Pub. Date: Oct. 17, 2024

(54) GREASE COMPOSITIONS

(71) Applicant: ExxonMobil Technology and Engineering Company, Spring, TX (US)

(72) Inventors: Christopher J. FOWLER, Houston, TX (US); Patrick L. YODER, Montgomery, TX (US)

(73) Assignee: ExxonMobil Technology and Engineering Company, Spring, TX (US)

(21) Appl. No.: 18/631,681

(22) Filed: Apr. 10, 2024

Related U.S. Application Data
(60) Provisional application No. 63/496,346, filed on Apr. 14, 2023.

(51) Int. Cl. C10M 101/00; C10M 117/00; C10M 169/02; C10M 177/00; C10N 10/02; C10N 20/02; C10N 70/00

(52) U.S. Cl. CPC C10M 101/00; C10M 117/00; C10M 169/02; C10M 177/00; C10M 2207/1253; C10M 2227/09; C10M 2290/02; C10M 2290/10; C10N 2010/02; C10N 2020/02; C10N 2070/00

(57) ABSTRACT

Grease compositions may be made from an oil basestock. For example, a grease composition may include: an oil basestock having: a kinematic viscosity (ASTM D445, 40° C.) of from 320 cSt to 520 cSt, a kinematic viscosity (ASTM D445, 100° C.) of from 22 cSt to 36 cSt, a viscosity index (ASTM D2270) of from 80 to 119, a pour point (ASTM D97) of −6° C. or less, and a saturate content (ASTM D7419) of 90 wt % or greater; and from 0.5 wt % to 15 wt % of a thickener, by total weight of the grease composition.

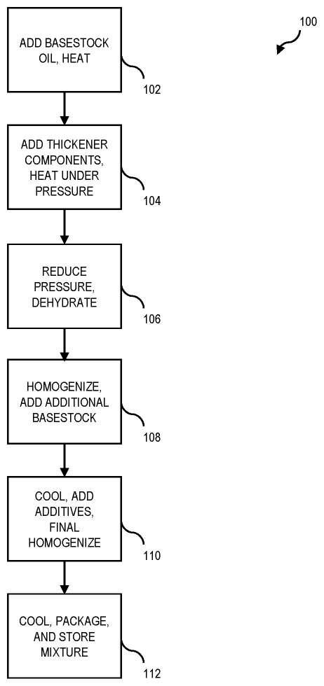

### FIELD OF INVENTION

This application relates to grease compositions and methods concerning the same.

### BACKGROUND

Grease is a necessary lubricant for much machinery and equipment. Standard grease typically includes an oil basestock suitable for the desired application along with a thickener and other additives.

The American Petroleum Institute (API) defines Group I oil basestocks as solvent-refined mineral oils; Group I oil basestocks contain the least saturates and highest amount of sulfur and generally have the lowest viscosity indices. Group I generally defines the bottom tier of lubricant performance. Group II and Group III oil basestocks are high viscosity index and very high viscosity index basestocks, respectively. The Group III oil basestocks generally contain fewer unsaturates and sulfur than the Group II oils. Group IV oil basestocks consist of polyalphaolefins, which are produced via the catalytic oligomerization of linear alphaolefins (LAOs). Group V includes all the other oil basestocks not included in Groups I through IV; Group V basestocks include lubricants based on or derived from esters.

It is well known in the art that a grease's apparent viscosity is a function of oil basestock viscosity and grease consistency, at the dispensing temperature. Various greases may be formulated to deliver tailored performance depending on temperature use, for example in cold-weather regions where ambient temperatures may be as low as −40° C. Additionally, greases may have varying characteristics including, but not limited to, dropping point, mechanical and/or shear stability, oxidation resistance, and the like, all of which may influence the performance and lubricating life of the grease.

### SUMMARY OF INVENTION

A first nonlimiting grease composition of the present disclosure includes: an oil basestock having: a kinematic viscosity (ASTM D445, 40° C.) of from 320 centistokes (cSt) to 520 cSt, a kinematic viscosity (ASTM D445, 100° C.) of from 22 cSt to 36 cSt, a viscosity index (ASTM D2270) of from 80 to 119, a pour point (ASTM D97) of −6° C. or less, and a saturate content (ASTM D7419) of 90 wt % or greater; and from 0.5 wt % to 15 wt % of a thickener, by total weight of the grease composition.

A second nonlimiting grease composition of the present disclosure includes: an oil basestock having: a kinematic viscosity (ASTM D445, 40° C.) of from 460 cSt to 520 cSt, a kinematic viscosity (ASTM D445, 100° C.) of from 32 cSt to 36 cSt, a viscosity index (ASTM D2270) of from 80 to 119, a pour point (ASTM D97) of −15° C. or less, and a saturate content (ASTM D7419) of 98 wt % or greater; and from 6 wt % to 10 wt % of a thickener, by total weight of the grease composition, wherein the thickener comprises a metal soap, and wherein a metal of the metal soap comprises: lithium, calcium, barium, sodium, aluminum, or any combination thereof.

A nonlimiting method of the present disclosure includes: heating an oil basestock, wherein the oil basestock has: a kinematic viscosity (ASTM D445, 40° C.) of from 320 cSt to 520 cSt, a kinematic viscosity (ASTM D445, 100° C.) of from 22 cSt to 36 cSt, a viscosity index (ASTM D2270) of from 80 to 119, a pour point (ASTM D97) of −6° C. or less, and a saturate content (ASTM D7419) of 90 wt % or greater; and mixing the oil basestock with a thickener and heating the mixture under pressure to form a grease; adding additional oil basestock to the grease to achieve the desired consistency; and cooling the grease.

These and other features and attributes of the disclosed compositions and methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following FIGURES are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

The FIGURE is a flow diagram of a nonlimiting example method according to the present disclosure.

### DETAILED DESCRIPTION

This application relates to grease compositions and methods concerning thereof.

The term “wt %” as used herein indicates percentage by weight, “vol %” as used herein indicates percentage by volume, “mol %” as used herein indicates percentage by mole, “ppm” as used herein indicates parts per million, and “ppm wt” and “wppm” are used interchangeably and mean parts per million on a weight basis. All concentrations herein, unless otherwise stated, are expressed on the basis of the total amount of the composition in question.

The term “polymer” as used herein refers to a substance comprising any two or more of the same or different repeating units/monomer units or units. The term “homopolymer” as used herein refers to a polymer having units that are the same. The term “copolymer” as used herein refers to a polymer having two or more units that are different from each other and includes terpolymers and the like. The term “terpolymer” as used herein refers to a polymer having three units that are different from each other. The term “different” as used herein as it refers to units indicates that the units differ from each other by at least one atom or are different isomerically. Likewise, the definition of polymer, as used herein, includes homopolymers, copolymers, terpolymers, and the like.

The term “oil base stock,” “oil basestock,” “base oil,” or simply “basestock,” and grammatical variations thereof as used herein refer to any base fluid that could be used in a lubricant including, but not limited to, a terpene, a mineral oil, a synthetic hydrocarbon, an ester, the like, or any combination thereof. An oil base stock as described herein may include Group I, II, III, IV, and V (as defined by American Petroleum Institute [API]) base oils, including any combination thereof.

### Base Stock

The present disclosure includes methods and compositions relating to grease comprising group II basestock oils, and additionally comprising either group I basestock oil or group IV basestock oil. Grease compositions of the present disclosure may allow for increased performance at low temperature conditions (e.g., temperature conditions of about −10° C. or below, or about −20° C. or below, or about-30° C. or below, or from about −40° C. to about −10° C.) as well as increased oxidation stability as compared to standard greases, without significant increases in cost. Many standard cold-weather greases may comprise a Group IV basestock oil comprising polyalphaolefins. Typical formulations including polyalphaolefins may be more expensive than, for example, formulations including Group II or Group I basestock oils. Additionally, use of polyalphaolefins as a basestock oil in grease compositions typically requires a higher weight percentage (wt %) of thickener to achieve a desired NLGI grade (as published by the National Lubricating Grease Institute; it should be noted that NLGI grade may be measured by ASTM D217), as compared with compositions using a Group II or Group I basestock oil. This increased thickener requirement may further add cost.

Grease compositions of the present disclosure, due to the use of extra-heavy Group II basestock oils, may allow for increased performance similar to or exceeding performance standards of greases formulated with Group IV basestocks (e.g., polyalphaolefins) while having lower cost and not requiring a higher wt % of thickener. Preferred embodiments of the present disclosure may meet DIN51825 standards (e.g., −30° C.) for low temperature torque (including starting and running). A “polyalphaolefin” and grammatical variants thereof as used herein, refers to a fully synthetic basestock oil produced via the catalytic oligomerization of linear alphaolefins.

Suitable Group II basestocks may have a kinematic viscosity (ASTM D445, 40° C.) of from 300 cSt to 600 cSt (or 320 cSt to 520 cSt, or 380 cSt to 520 cSt, or 450 cSt to 520 cSt) and a kinematic viscosity (ASTM D445-21, 100° C.) of from 22 cSt to 40 cSt (or 22 cSt to 36 cSt, or 27 cSt to 36 cSt, or 32 cSt to 36 cSt). Suitable Group II basestocks may have a viscosity index (ASTM D2270) of from 80 to 119 (or 95 to 115). Suitable basestocks may have a pour point (IP 15 or ASTM D97) of from −35° C. to −6° C. (or −35° C. to −15° C., or −6° C. or less, or −15° C. or less). Suitable Group II basestocks may have a saturate content (ASTM D7419) of 90 wt % or greater (or 90 wt % to 99.99 wt %, or 95 wt % to 99.99 wt %, or 98 wt % to 99.99 wt %, or 90 wt % to 99 wt %, or 95 wt % to 99 wt %, or 98 wt % to 99 wt %, or 95 wt % or greater, or 98 wt % or greater, or 99 wt % or greater). Other characteristics of suitable Group II heavy basestocks may include, but are not limited to: basestock color (ASTM D6045) from L1.5 to L0.5 (or L1.5 to L1.0, or L1.0 to L0.5); carbon residue (ASTM D4530) from 0.0001 mass % to 0.1 mass %, or 0.001 mass % to 0.01 mass %, or 0 mass % to 0.1 mass %, or 0 mass % to 0.01 mass %, or 0.1 mass % or less, or 0.01 mass % or less; cloud point (ASTM D2500) from −60° C. to −2° C., or −60° C. to −30° C., or −30° C. to −2° C., or −2° C. or less, or −30° C. or less, or −60° C. or less; flashpoint (ASTM D92) from 250° C. and 300° C., or 250° C. to 275° C., 275° C. to 300° C., or 250° C. or greater.

Grease compositions of the present disclosure may comprise from 60 wt % to 99.5 wt % (or 70 wt % to 99.5 wt %, or 80 wt % to 99.5 wt %, or 60 wt % to 95 wt %, or 70 wt % to 95 wt %, or 80 wt % to 95 wt %, or 80 wt % to 94 wt %, or 80 wt % to 93 wt %, or 85 wt % to 95 wt %, or 85 wt % to 94 wt %, or 85 wt % to 93 wt %) of the basestock, by total weight of the grease composition.

### Thickener

The present disclosure may include compositions comprising a thickener, as described above. The thickener preferably comprises a simple calcium, lithium, aluminum, sodium, and/or barium soap of a fatty acid, such as, for example, stearic acid or 12-hydroxystearic acid, or the complex calcium, lithium, barium, sodium, and/or aluminum soaps/salts of fatty acids. Mono-carboxylic acids or benzoic acids may be preferred fatty acids. Low molecular weight di-acid derivatives such as azelaic acid may be preferred complexing agents included to form complex soaps. Particularly preferred are lithium, barium, calcium, sodium, or aluminum simple or complex soaps and mixtures thereof, with lithium soaps being particularly preferred. Particularly preferred are lithium soap/salts formed by the in-situ saponification reaction of 12-hydroxystearic acid with lithium hydroxide. Other examples of thickeners may include, but are not limited to, polyurca, organophilic clay, Teflon, mica gel, silica gel, calcium sulfonate, polytetrafluoroethylene, carbon black, the like, or any combination thereof.

The grease compositions of the present disclosure may comprise thickener at a concentration of from about 0.5 wt % and about 30 wt % (or 0.5 wt % to 20 wt %, or 0.5 wt % to 15 wt %, or 0.5 wt % to 10 wt %, or 1 wt % to 10 wt %, or 1 wt % to 8 wt %, or about 7 wt %) of the grease composition, by total weight of the grease composition. It should be noted that concentrations outside the aforementioned ranges are additionally contemplated. Additionally, it should be noted that concentrations of thickener in grease compositions of the present disclosure may depend on factors including, but not limited to, the thickener type, oil basestock type, oil basestock properties (e.g., kinematic viscosity, viscosity index, the like, or any combination thereof), application temperature, the like, or any combination thereof.

### Antioxidant

Grease compositions of the present disclosure may further comprise an antioxidant.

Antioxidants retard the oxidative degradation of base stocks during service. Such degradation may result in reduction in useful grease life due to formation of deposits on metal surfaces, the presence of sludge, or a viscosity increase in the grease. One skilled in the art knows a wide variety of oxidation inhibitors that are useful in lubricating oil compositions.

Useful antioxidants may include hindered phenols. These phenolic antioxidants may be ashless (metal-free) phenolic compounds or neutral or basic metal salts of certain phenolic compounds. Typical phenolic antioxidant compounds are the hindered phenolics, which are the ones which contain a sterically hindered hydroxyl group. Typical phenolic antioxidants include the hindered phenols sterically hindered with t-butyl groups and additionally substituted with C₆+ alkyl groups and the alkylene coupled derivatives of these hindered phenols. Examples of phenolic materials of this type include, but are not limited to, 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include, but are not limited to, for example hindered 2,6-di-alkyl-phenolic propionic ester derivatives. Bis-phenolic antioxidants may also be advantageously used in combination with the instant disclosure. Examples of ortho-coupled phenols include, but are not limited to: 2,2′-bis(4-heptyl-6-t-butyl-phenol); 2,2′-bis(4-octyl-6-t-butyl-phenol); and 2,2′-bis(4-dodecyl-6-t-butyl-phenol). Para-coupled bisphenols include, but are not limited to, for example 4,4′-bis(2,6-di-t-butyl phenol) and 4,4′-methylene-bis(2,6-di-t-butyl phenol).

Effective amounts of one or more catalytic antioxidants may also be used. The catalytic antioxidants comprise an effective amount of a) one or more oil soluble polymetal organic compounds; and, effective amounts of b) one or more substituted N,N′-diaryl-o-phenylenediamine compounds or c) one or more hindered phenol compounds; or a combination of both b) and c). Catalytic antioxidants are more fully described in U.S. Pat. No. 8,048,833, herein incorporated by reference in its entirety.

Non-phenolic oxidation inhibitors that may be used include aromatic amine antioxidants and these may be used either as such or in combination with phenolics. Typical examples of non-phenolic antioxidants include, but are not limited to: alkylated and non-alkylated aromatic amines such as aromatic monoamines of the formula R⁸R⁹R¹⁰N where R⁸ is an aliphatic, aromatic or substituted aromatic group, R⁹ is an aromatic or a substituted aromatic group, and R¹⁰ is H, alkyl, aryl or R¹¹S(O)xR¹² where R¹¹ is an alkylene, alkenylene, or aralkylene group, R¹² is a higher alkyl group, or an alkenyl, aryl, or alkaryl group, and x is 0, 1 or 2. The aliphatic group R⁸ may contain from 1 to 20 carbon atoms, and preferably contains from 6 to 12 carbon atoms. Preferably, both R⁸ and R⁹ are aromatic or substituted aromatic groups, and the aromatic group may be a fused ring aromatic group such as naphthyl. Aromatic groups R⁸ and R⁹ may be joined together with other groups such as S.

Typical aromatic amines antioxidants have alkyl substituent groups of at least 6 carbon atoms. Examples of aliphatic groups include, but are not limited to, hexyl, heptyl, octyl, nonyl, and decyl. Generally, the aliphatic groups will not contain more than 14 carbon atoms. The general types of amine antioxidants useful in the present compositions include, but are not limited to, diphenylamines, phenyl naphthylamines, phenothiazines, imidodibenzyls and diphenyl phenylene diamines. Mixtures of two or more aromatic amines are also useful. Polymeric amine antioxidants can also be used. Particular examples of preferred aromatic amine antioxidants useful in the present disclosure include, but are not limited to: p,p′-dioctyldiphenylamine; t-octylphenyl-alpha-naphthylamine; phenyl-alphanaphthylamine; and p-octylphenyl-alpha-naphthylamine.

Amine antioxidants in this disclosure may include polymeric or oligomeric amines which are the polymerization reaction products of one or more substituted or hydrocarbyl-substituted diphenyl amines, one or more unsubstituted or hydrocarbyl-substituted phenyl naphthyl amines, or both one or more of unsubstituted or hydrocarbyl-substituted diphenylamine with one or more unsubstituted or hydrocarbyl-substituted phenyl naphthylamine.

Other more extensive oligomers are within the scope of this disclosure. Examples can be found in U.S. Pat. No. 8,492,321.

Preferred antioxidants may include, but are not limited to, hindered phenols, arylamines, and the like. These antioxidants may be used individually by type or in combination with one another. Antioxidant additives may be used in an amount, by total weight of the grease composition, from 0.01 wt % to 5 wt %, or preferably 0.01 wt % to 1.5 wt %, or more preferably 0.0 wt % to 1.5 wt %, or more preferably 0.0 wt % to 1.0 wt %.

### Antiwear Additive

Grease compositions of the present disclosure may further comprise an antiwear additive.

A metal alkylthiophosphate and more particularly a metal dialkyl dithio phosphate in which the metal constituent is zinc, or zinc dialkyl dithio phosphate (ZDDP) may be a useful antiwear additive of the grease compositions of this disclosure. ZDDP can be derived from primary alcohols, secondary alcohols or mixtures thereof. ZDDP compounds generally are of the formula Zn[SP(S)(OR¹)(OR²)]₂ where R¹ and R² are C₁-C₁₈ alkyl groups, preferably C₂-C₁₂ alkyl groups. These alkyl groups may be straight chain or branched. Alcohols used in the ZDDP can be 2-propanol, butanol, secondary butanol, pentanols, hexanols such as 4-methyl-2-pentanol, n-hexanol, n-octanol, 2-ethyl hexanol, alkylated phenols, and the like. Mixtures of secondary alcohols or of primary and secondary alcohol can be preferred. Alkyl aryl groups may also be used.

ZDDP or any antiwear additive may be typically used in amounts of from 0.4 wt % to 2.0 wt %, preferably from 0.5 wt % to 1.5 wt %, and more preferably from 0.6 wt % to 0.8 wt %, based on the total weight of the grease composition, although more or less can often be used advantageously. Preferably, the ZDDP is a secondary ZDDP and present in an amount of from 0.6 wt % to 1.0 wt % of the total weight of the grease composition.

More generally, other types of suitable antiwear additives can include, but are not limited to, for example, metal salts of a carboxylic acid. The metal can be a transition metal or a mixture of transition metals, such as one or more metals from Group 10, 11, or 12 of the IUPAC periodic table. The carboxylic acid can be an aliphatic carboxylic acid, a cycloaliphatic carboxylic acid, an aromatic carboxylic acid, or a mixture thereof.

### Other Additives

The grease compositions may additionally include other performance additives known in the art such as corrosion inhibitors, rust inhibitors (e.g., metal naphthenates or sulphonates based on sodium, barium, zinc, the like, or any combination thereof), metal deactivators, extreme pressure additives (e.g., calcium carbonate, molybdenum disulfide, graphite, the like, or any combination thereof), order modifiers, tackiness agents, water shedding agents, dyes, polymers, detergents, the like, or any combination thereof. When grease compositions include one or more of the foregoing additives, the additive(s) may be blended into the compositions in an amount sufficient for it to perform its intended function.

### Grease Formation

A preferred method for formation of a grease from basestocks involves, the addition of thickener components to the basestock(s), and potentially other compounds such as complexing agents, heating under pressure to the desired top temperature, a pressure reduction and dehydration process, homogenization, moderate cooling, additization with possible additional homogenization, and final cooling to form a final product.

A nonlimiting example method 100 for grease formation is shown in the FIGURE. A basestock oil is first added to the reaction vessel and heated (102). Subsequently, one or more thickener components are added to the basestock, heated until melted, one or more additional thickener components are added, and further heated under pressure to reach the desired reaction conditions (104). Once the reaction is complete, the pressure is reduced to dehydrate the mixture (106). Once dehydrated, the mixture will be homogenized to ensure that the grease is well-mixed and the components are evenly dispersed. Subsequently additional basestock oil may be added (108) to promote the desired final grease consistency. Moderate cooling and inclusion of additive components may then take place with additional homogenization (110). Finally, the resulting grease is cooled (112) for packaging and storage. It should be noted that the thickener may be, at least partially, formed in-situ in the basestock oil through, for example, a saponification reaction of a fatty component and an alkali metal hydroxide. It should additionally be noted that a complexing agent such as, for example, azelaic acid, may be used in the saponification reaction.

As another nonlimiting example using the basic method described in reference to the FIGURE above, a grease composition may be formed as follows. First a basestock and a fatty acid component, such as 12-hydroxystearic acid, are heated to melt the fatty acid component into a liquid (102), approximately 200° F. Next, an alkali metal hydroxide, such as lithium hydroxide, is mixed with water into the basestock. Thus, in this example the combination of the fatty acid component (12-hydroxystearic acid) and the alkali metal hydroxide (lithium hydroxide) will then react during the processing to form a fatty acid salt that is the thickener: lithium 12-hydroxystearic acid. The resulting mixture is heated (104) under pressure to a temperature that is generally between 300° F. and 400° F. The precise temperature to heat the mixture is selected to allow the reaction between the fatty acid, and alkali metal hydroxide to occur but is less than the flash point of the basestock (or mixture of basestocks). As the desired temperature is reached, the mixture is held under pressure, and the addition of nitrogen gas may be used to maintain the desired pressure, which is generally from 80 psi to 140 psi. The desired temperature and pressure are held to allow the mixture time to react, generally from 45 min to 100 min. Once the reaction is substantially completed, pressure is reduced to 0 psi to 50 psi to allow for grease dehydration while the temperature is maintained at between 300° F. and 400° F. (106). Once the grease is dehydrated and homogenized, the temperature is reduced to 160° F. to 180° F. At this point, other additives may be added if desired and additional basestock is added to the mixture to achieve the desired consistency (108, 110). As the additional basestock is added, the grease is tested according to ASTM D217 to measure penetration to achieve the desired consistency of the grease. Once the proper consistency is reached and any desired additives are included, the grease may undergo final homogenization (110); this generally occurs by forcing the mixture through small openings at high pressure to ensure that the grease is well mixed and/or dispersed. A well-known type of homogenizer used for grease manufacture is a Gaulin mill. After the homogenization the grease may be cooled, packaged, and stored for later use (112). One of ordinary skill in the art will be able to adjust parameters during formation of a grease composition in order to achieve desired properties of said grease composition. Such parameters may include, but are not to be limited to, consistency, heating time, temperature, the like, or any combination thereof. It should additionally be appreciated that while the formation of a grease may be described above as a batch process, one of ordinary skill in the art would be able to form a grease composition of the present disclosure in a continuous process.

To facilitate a better understanding of the embodiments of the present invention, the following examples of preferred or representative embodiments are given. In no way should the following examples be read to limit, or to define, the scope of the invention.

### EXAMPLES

An inventive example grease (IE1) was prepared comprising a Group II (API) extra heavy base stock, the Group II extra heavy basestock comprising EHC™ 340 MAX, to be available commercially from ExxonMobil™. IE1 comprised about 7 wt % thickener, the thickener being simple lithium soap. Additionally a comparative example (CE1) was prepared in the same manner except with a standard Group I (API) base stock and also included about 7 wt % thickener comprising simple lithium soap.

The samples were tested for mobility at 150 psi using a Standard Oil Development (SOD) pressure viscosimeter according to procedures outlined in the United States Steel, Lubrication Engineers Manual (using a #1 40-1 ratio capillary, 6.0 inches long with approximately 0.150 inch diameter opening). Additionally, samples were tested for low temperature torque (including starting torque and running torque) at −20° C. and −30° C. by ASTM D1478. Results of testing can be seen in Table 1 below.

TABLE 1
Low Temperature Testing Results.

| | Test | | |
|---|---|---|---|
| | Temp | CE1 | IE1 |
| Test (units) [standard method] | (° C.) | Result | Result |
| Low Temperature Grease Mobility | −18 | 1.4 | 5.5 |
| (g/min) [US Steel] | | | |
| Low Temp. Starting Torque (g-cm) | −20 | 3750 | 850 |
| [ASTM D1478] | | | |
| Low Temp. Running Torque (g-cm) | −20 | 610 | 440 |
| [ASTM D1478] | | | |
| Low Temp. Starting Torque (g-cm) | −30 | 26700 | 3260 |
| [ASTM D1478] | | | |
| Low Temp. Running Torque (g-cm) | −30 | 4910 | 1420 |
| [ASTM D1478] | | | |

The results displayed indicate a 290% improved mobility at low temperatures for IE1 as compared with CE1, indicating increased pumpability. Additionally, at −20° C., IE1 showed reduced torque, including 80% lower starting torque and 30% lower running torque as compared with CE1. Furthermore, at −30° C., IE1 showed significantly reduced torque including 90% lower starting torque and 70% lower running torque as compared with CE1.

### Additional Embodiments

Embodiment 1. A grease composition comprising: an oil basestock having: a kinematic viscosity (ASTM D445, 40° C.) of from 320 cSt to 520 cSt, a kinematic viscosity (ASTM D445, 100° C.) of from 22 cSt to 36 cSt, a viscosity index (ASTM D2270) of from 80 to 119, a pour point (ASTM D97) of −6° C. or less, and a saturate content (ASTM D7419) of 90 wt % or greater; and from 0.5 wt % to 15 wt % of a thickener, by total weight of the grease composition.

Embodiment 2. The grease composition of claim 1, wherein the oil basestock is an API Group II basestock.

Embodiment 3. The grease composition of Embodiment 2, wherein the oil basestock further comprises either an API Group I basestock or an API Group IV basestock.

Embodiment 4. The grease composition of Embodiment 1 or 2, wherein the oil basestock does not comprise a polyalphaolefin.

Embodiment 5. The grease composition of any one of Embodiments 1-4, wherein the oil basestock has a concentration in the grease composition of from 60 wt % to 99.5 wt %, by total weight of the grease composition.

Embodiment 6. The grease composition of any one of Embodiments 1-5, wherein the thickener comprises simple lithium soap.

Embodiment 7. The grease composition of any one of Embodiments 1-5, wherein the thickener comprises complex lithium soap.

Embodiment 8. The grease composition of any one of Embodiments 1-5, wherein the thickener comprises simple lithium soap, complex lithium soap, polyurea, an organophilic clay, Teflon, mica gel, silica gel, calcium sulfonate, polytetrafluoroethylene, carbon black, or any combination thereof.

Embodiment 9. The grease composition of any one of Embodiments 1-5, wherein the thickener comprises a metal soap, and wherein a metal of the metal soap comprises: lithium, calcium, barium, sodium, aluminum, or any combination thereof.

Embodiment 10. The grease composition of any one of Embodiments 1-9, wherein the oil basestock has: a kinematic viscosity (ASTM D445, 40° C.) of from 450 cSt to 520 cSt, a kinematic viscosity (ASTM D445, 100° C.) of from 32 cSt to 36 cSt, a pour point (ASTM D97) of −15° C. or less, and a saturate content (ASTM D7419) of 95 wt % or greater.

Embodiment 11. The grease composition of any one of Embodiments 1-10, further comprising from 0.5 wt % to 10.0 wt % of a detergent, by total weight of the grease composition.

Embodiment 12. The grease composition of any one of Embodiments 1-11, from 0.01 wt % to 5 wt % of an antioxidant, by total weight of the grease composition.

Embodiment 13. The grease composition of any one of Embodiments 1-12, from 0.4 wt % to 2.0 wt % of an antiwear additive, by total weight of the grease composition.

Embodiment 14. A grease composition comprising: an oil basestock having: a kinematic viscosity (ASTM D445, 40° C.) of from 460 cSt to 520 cSt, a kinematic viscosity (ASTM D445, 100° C.) of from 32 cSt to 36 cSt, a viscosity index (ASTM D2270) of from 80 to 119, a pour point (ASTM D97) of −15° C. or less, and a saturate content (ASTM D7419) of 98 wt % or greater; and from 6 wt % to 10 wt % of a thickener, by total weight of the grease composition, wherein the thickener comprises a metal soap, and wherein a metal of the metal soap comprises: lithium, calcium, barium, sodium, aluminum, or any combination thereof.

Embodiment 15. A method comprising: heating an oil basestock, wherein the oil basestock has: a kinematic viscosity (ASTM D445, 40° C.) of from 320 cSt to 520 cSt, a kinematic viscosity (ASTM D445, 100° C.) of from 22 cSt to 36 cSt, a viscosity index (ASTM D2270) of from 80 to 119, a pour point (ASTM D97) of −6° C. or less, and a saturate content (ASTM D7419) of 90 wt % or greater; and mixing the oil basestock with a thickener and heating the mixture under pressure to form a grease; adding additional oil basestock to the grease to achieve the desired consistency; and cooling the grease.

Embodiment 16. The method of Embodiment 15, further comprising: reacting a fatty component and an alkali-metal hydroxide so as to form the thickener through saponification.

Embodiment 17. The method of Embodiment 16, wherein the saponification forms a simple lithium soap, a complex lithium soap, or a combination thereof.

Embodiment 18. The method of any one of Embodiments 15-17, further comprising:
(i) dehydrating the mixture after heating the mixture under pressure to form a grease, or
(ii) homogenizing the mixture after adding additional oil basestock to the grease to achieve the desired consistency, or both (i) and (ii).

Embodiment 19. The method of Embodiment 15 or 18, wherein the thickener comprises simple lithium soap, complex lithium soap, polyurea, an organophillic clay, Teflon, mica gel, silica gel, calcium sulfonate, polytetrafluoroethylene, carbon black, or any combination thereof.

Embodiment 20. The method of any one of Embodiments 15-19, wherein the grease composition comprises from 0.5 wt % to 10 wt % of the thickener, by total weight of the grease composition.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

What is claimed is:

1. A grease composition comprising:
an oil basestock having:
a kinematic viscosity (ASTM D445, 40° C.) of from 320 cSt to 520 cSt,
a kinematic viscosity (ASTM D445, 100° C.) of from 22 cSt to 36 cSt,
a viscosity index (ASTM D2270) of from 80 to 119,
a pour point (ASTM D97) of −6° C. or less, and
a saturate content (ASTM D7419) of 90 wt % or greater; and
from 0.5 wt % to 15 wt % of a thickener, by total weight of the grease composition.

2. The grease composition of claim 1, wherein the oil basestock is an API Group II basestock.

3. The grease composition of claim 2, wherein the oil basestock further comprises either an API Group I basestock or an API Group IV basestock.

4. The grease composition of claim 1, wherein the oil basestock does not comprise a polyalphaolefin.

5. The grease composition of claim 1, wherein the oil basestock has a concentration in the grease composition of from 60 wt % to 99.5 wt %, by total weight of the grease composition.

6. The grease composition of claim 1, wherein the thickener comprises simple lithium soap.

7. The grease composition of claim 1, wherein the thickener comprises complex lithium soap.

8. The grease composition of claim 1, wherein the thickener comprises simple lithium soap, complex lithium soap, polyurea, an organophilic clay, Teflon, mica gel, silica gel, calcium sulfonate, polytetrafluoroethylene, carbon black, or any combination thereof.

9. The grease composition of claim 1, wherein the thickener comprises a metal soap, and wherein a metal of the metal soap comprises: lithium, calcium, barium, sodium, aluminum, or any combination thereof.

10. The grease composition of claim 1, wherein the oil basestock has:
a kinematic viscosity (ASTM D445, 40° C.) of from 450 cSt to 520 cSt,
a kinematic viscosity (ASTM D445, 100° C.) of from 32 cSt to 36 cSt,
a pour point (ASTM D97) of −15° C. or less, and
a saturate content (ASTM D7419) of 95 wt % or greater.

11. The grease composition of claim 1, further comprising from 0.5 wt % to 10.0 wt % of a detergent, by total weight of the grease composition.

12. The grease composition of claim 1, from 0.01 wt % to 5 wt % of an antioxidant, by total weight of the grease composition.

13. The grease composition of claim 1, from 0.4 wt % to 2.0 wt % of an antiwear additive, by total weight of the grease composition.

14. A grease composition comprising:
an oil basestock having:
a kinematic viscosity (ASTM D445, 40° C.) of from 460 cSt to 520 cSt,
a kinematic viscosity (ASTM D445, 100° C.) of from 32 cSt to 36 cSt,
a viscosity index (ASTM D2270) of from 80 to 119,
a pour point (ASTM D97) of −15° C. or less, and
a saturate content (ASTM D7419) of 98 wt % or greater; and
from 6 wt % to 10 wt % of a thickener, by total weight of the grease composition, wherein the thickener comprises a metal soap, and wherein a metal of the metal soap comprises: lithium, calcium, barium, sodium, aluminum, or any combination thereof.

15. A method comprising:
heating an oil basestock, wherein the oil basestock has:
a kinematic viscosity (ASTM D445, 40° C.) of from 320 cSt to 520 cSt,
a kinematic viscosity (ASTM D445, 100° C.) of from 22 cSt to 36 cSt,
a viscosity index (ASTM D2270) of from 80 to 119,
a pour point (ASTM D97) of −6° C. or less, and
a saturate content (ASTM D7419) of 90 wt % or greater; and
mixing the oil basestock with a thickener and heating the mixture under pressure to form a grease;
adding additional oil basestock to the grease to achieve the desired consistency; and
cooling the grease.

16. The method of claim 15, further comprising: reacting a fatty component and an alkali-metal hydroxide so as to form the thickener through saponification.

17. The method of claim 16, wherein the saponification forms a simple lithium soap, a complex lithium soap, or a combination thereof.

18. The method of claim 15, further comprising:
(i) dehydrating the mixture after heating the mixture under pressure to form a grease, or
(ii) homogenizing the mixture after adding additional oil basestock to the grease to achieve the desired consistency, or
both (i) and (ii).

19. The method of claim 15, wherein the thickener comprises simple lithium soap, complex lithium soap, polyurea, an organophillic clay, Teflon, mica gel, silica gel, calcium sulfonate, polytetrafluoroethylene, carbon black, or any combination thereof.

20. The method of claim 15, wherein the grease composition comprises from 0.5 wt % to 10 wt % of the thickener, by total weight of the grease composition.
